(19) United States
(12) Patent Application Publication
(10) Pub. No.: US 2002/0038420 A1
(43) Pub. Date: Mar. 28, 2002

(54) Method for efficient public key based certification for mobile and desktop environments

(76) Inventors: Timothy S. Collins, San Francisco, CA (US); Chin Ming Kuo, Sunnyvale, CA (US)

Correspondence Address: BEYER WEAVER & THOMAS LLP, P.O. BOX 778, BERKELEY, CA, 94704-0778, US

(21) Appl. No.: 09/832,511

(22) Filed: Apr. 10, 2001

Related U.S. Application Data
(60) Provisional application No. 60/197,153, filed on Apr. 13, 2000.

(51) Int. Cl. H04L 9/30

(52) U.S. Cl. 713/156; 380/277; 713/175; 380/30; 713/157

(57) ABSTRACT

A method for forming a certificate is provided. Generally, a first public key of a first encryption type is placed in the certificate. A second public key of a second encryption type is also placed in the certificate.

The invention also provides a method for transmitting a document. Generally, the document is digitally signed. An information string is encrypted with a private key to create a signature wherein the private key is related to a public key in a certificate, wherein the certificate comprises a first public key and a second public key, wherein the public key related to the private key is the second public key, and where the information string contains the document. The signature is attached to the information string to create a digitally signed document.

### RELATED APPLICATION DATA

The present application claims priority from U.S. Provisional Patent Application No. 60/197,153 for METHODS FOR EFFICIENT PUBLIC KEY BASED CERTIFICATION INFRASTRUCTURE FRAMEWORK FOR MOBILE AND DESKTOP ENVIRONMENTS filed on Apr. 13, 2000, the entirety of which is incorporated herein by reference for all purposes.

### BACKGROUND OF THE INVENTION

The present invention relates to public key cryptographic systems. More particularly, the present invention relates to public key cryptographic systems, which may be used on hand held computers.

Public key infrastructure (PKI) certificate systems are becoming the security foundation for conducting commercial activities on an open network, such as the Internet. To ensure a high level of security, the de facto standard PKI system is based on the Rivest, Shamir, Adleman algorithm (RSA) typically uses a high bit length (1024 bits) key to prevent compromising underlying infrastructure. The high demand on computing power causes a limitation on the use of RSA™ based PKI on compact devices. It may take as long as 10 minutes for some hand held devices (or personal digital assistants PDA's) to perform a decryption needed under an RSA based PKI. More compact public key algorithms, such as the Elliptic Curve Cryptosystem (ECC) or the NTRU Cryptosystem can achieve the same (or higher) level of security with much smaller computing requirements. However, PKI infrastructure based on ECC algorithms is not widely available. Currently, ECC and NTRU algorithms may not be as generally used to provide asymmetric keys for a server using an RSA based PKI infrastructure.

According to “The Elliptic Curve Cryptosystem” by Certicom of Ontario Canada, published April, 1997 and updated July 2000, incorporated by reference, ECC algorithms with a 160-bit modulus provide more security than RSA algorithms with a 1024 bit modulus. As a result, ECC algorithms may provide more security than RSA algorithms with greater efficiency, smaller key size, and less bandwidth. The NTRU Cryptosystem from NTRU Cryptosystem Inc. of Burlington, Mass. claims even a faster encryption and decryption. Therefore ECC and NTRU type security may provide better security for other compact devices, in addition to PDA's, such as wireless devices, smart cards, tokens, and other systems with either constrained bandwidth or limited processing power. Although it may be desirable to communicate with such devices securely over an open network, such as the Internet, encryption or decryption by such devices using the RSA standard may be too slow or impossible.

As more and more commerce is performed over limited processing devices, such as hand held computers, embedded devices, and wireless phones it would be desirable to provide a PKI system that provides an RSA based certificate, but allows a faster, lower key size, and lower bandwidth encryption and decryption.

### SUMMARY OF THE INVENTION

To achieve the foregoing and other objects and in accordance with the purpose of the present invention for forming a certificate, generally, a first public key of a first encryption type is placed in the certificate. A second public key of a second encryption type is also placed in the certificate.

The invention also provides a method for transmitting a document. A document is digitally signed. An information string is encrypted with a private key to create a signature, wherein the private key is related to a public key in a certificate, wherein the certificate comprises a first public key and a second public key, wherein the public key related to the private key is the second public key and where the information string contains the document. The signature is attached to the information string to create a digitally signed document.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic illustration of a system, which may use the invention.

FIG. 2 is a high level flow chart of the generation of a certificate according to a preferred embodiment of the invention.

FIG. 3 is a schematic view of an example of a certificate formed from the first and second public keys.

FIG. 4 is a schematic view of the certificate information.

FIG. 5 is a schematic illustration of the generation by a PDA of a digitally signed document and the verification of the signed document by a server.

FIG. 6 is a flow chart of the generation of the digitally signed document.

FIG. 7 is a flow chart of the authentication of the signed document by a server.

FIG. 8 is a flow chart for initiating a secure session, initiated by a PDA, used in another embodiment of the invention.

FIG. 9 is a flow chart for the completion of initiating a secure session.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

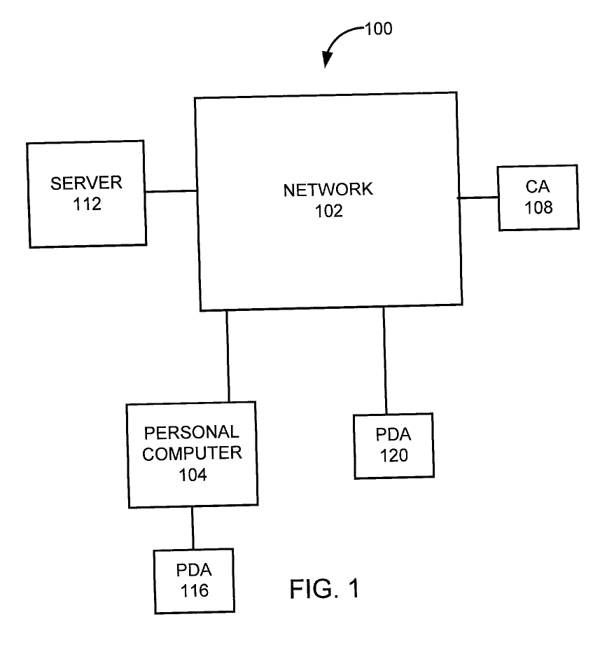

To facilitate discussion, FIG. 1 is a schematic illustration of a system 100, which may use the invention. The system 100 comprises a network 102 connected to a server 112 and a certificate authority (CA) 108. A personal computer 104 may connect to the server through the network 102. A personal digital assistant (PDA) 120 may be directly connected to the network 102 or a personal digital assistant (PDA) 116 may be connected to the network 102 through the personal computer 104. The network 102 may be an open network, such as the Internet, where it would be desirable to use a public key infrastructure to provide secure communication. A large enough percentage of devices on the Internet use an RSA based PKI system, such that if the server 112 does not use an RSA based PKI system, a large percentage of users would not be able to create a secure connection with the server 112. For this reason, the server 112 uses an RSA based PKI system. Although processing times for PDA's normally require undue amounts of time to process conventional RSA keys, since the server is able to use an inventive RSA key, the PDA's 116, 120 may be able to securely communicate with the server 112 without an undue wait period.

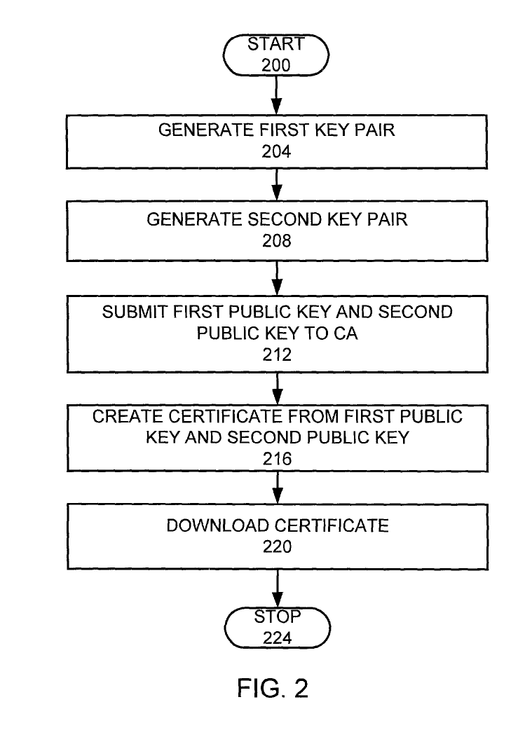

FIG. 2 is a high level flow chart of the generation of a certificate according to a preferred embodiment of the invention. A first key pair is generated (step 204). The first key pair comprises a first public key and a first private key. In the preferred embodiment, the first key pair is an RSA based key pair, where the first public key is related to the first private key through the RSA algorithm. In a first embodiment, the first key pair is generated by the PC 104. In a second embodiment, the first key pair is generated by one of the PDA's 116, 120. In a third embodiment, the first key pair is generated by the server 112. A second key pair is generated (step 208). The second key pair is generated using a different algorithm than the first key pair. In the preferred embodiment the second key pair is generated using an Elliptic Curve Cryptosystem (ECC) developed by Certicom™ of Ontario, Canada. In one embodiment, the second key pair is generated by the PC 104. In another embodiment, the second key pair is generated by one of the PDA's 116, 120. In another embodiment, the second key pair is generated by the server 112. In another preferred embodiment, the second key pair is generated using an NTRU Cryptosystem.

The first public key and second public key are then sent to the certificate authority (CA) 108 (step 212). The first public key and second public key may be sent by the server 112, personal computer 104, or PDA's 116, 120 to the CA. In the preferred embodiment, the first and second public keys are submitted to the CA 108 according to the standards of Public-Key Cryptography Standard #10 version 1.7 (PKCS #10 vl. 7) published by RSA Security™ of Massachusetts, where the first public key is designated as a public key and the second public key is designated as an extension. The ASN.1 standard is used to describe the extension designating the type of extension, which may be ECC, the length, and the value of the extension. In other embodiments, other standards may be used to submit the first and second public keys to the CA 108.

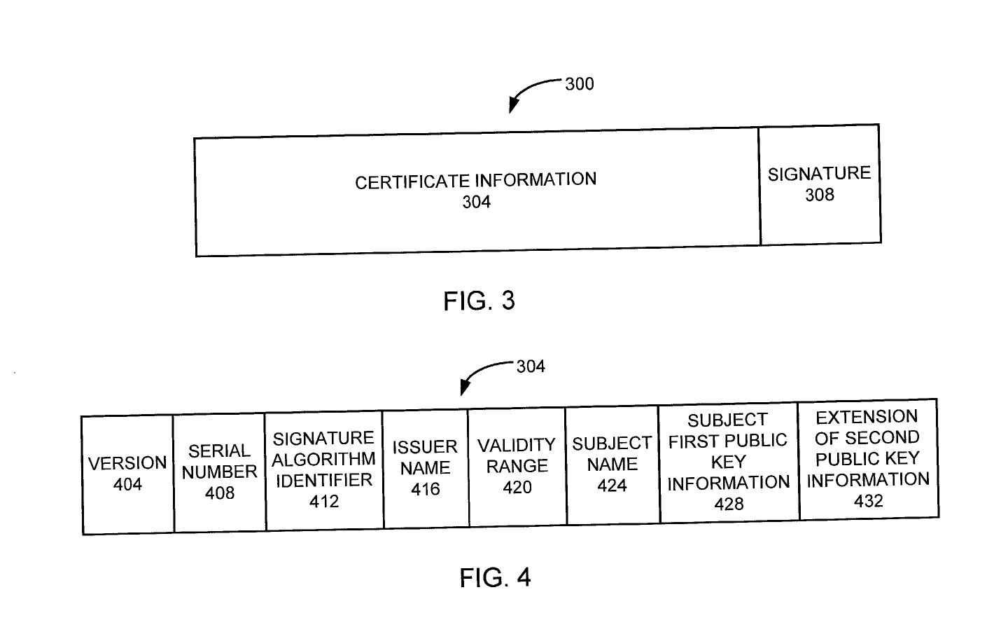

The CA 108 creates a certificate from the first public key and second public key (step 216). In the preferred embodiment the first public key and the second public key are combined to form a certificate that is compliant with the CCITT Recommendation X.509: The Directory-Authentication Framework (1988) with the additional amendments to allow extensions. FIG. 3 is a schematic view of an example of a certificate 300 formed by the CA 108 from the first and second public keys. The certificate 300 comprises a certificate information string 304 and a digital signature 308 of the CA 108. The digital signature 308 of the CA 108 may be an encrypted hash of the certificate information 304, where the encryption may be performed with the private key of the CA 108 and where the hash function to perform the hash may be placed in the certificate information 304. FIG. 4 is a schematic view of the certificate information string 304. The version field 404 may specify the version of the certificate. The serial number field 408 may specify a unique serial number for the certificate. The signature algorithm identifier field 412 may specify the hash function encryption algorithm used for forming the digital signature 308. The issuer name field 416 may specify the issuer of the certificate. The validity field 420 may specify the date range in which the certificate is valid. The subject name field 424 specifies the subject's name. The subject first public key information field 428 specifies information about the first public key, such as the public key type, value, and length of the first public key. In the preferred embodiment, the public key type of the first public key designates RSA encryption. X.509 has been amended to allow extensions. The extension of second public key information 432 specifies information about the second public key, such as the public key type, value, and length of the second public key. In the preferred embodiment of the invention, the public key type of the second public key designates ECC encryption. In an alternative embodiment of the invention, the public key type of the second public key designates NTRU encryption. In another embodiment the second public key designation is ECC encryption and a third public key designation is NTRU encryption. Thus the invention provides a certificate with a first public key of a first encryption type and a second public key of a second encryption type, where the first encryption type is different from the second encryption type. The second encryption type may be faster than the first encryption type in that encryption using the second type of encryption is generally performed faster than encryption using the first type of encryption.

The certificate 300 may then be downloaded to one of the PDA's 116, 120, the personal computer 104, or the server 112 or may be stored in a certificate repository (step 220). If the certificate 300 is downloaded to the personal computer 104, the personal computer may 104 may transfer the certificate 300 to the PDA 116.

Various types of certifications and keys may be used in transactions over a network. In an example of a communication between a PDA 120 and the server 112 over the Internet, the PDA 120 and server 112 may perform a Secure Socket Layer (SSL) protocol handshake. In an SSL handshake the PDA 120 may first send the server 112 the PDA's SSL version number, cipher settings, randomly generated data, and other information the server 112 needs to communicate with the PDA 120. The server 112 may then send the PDA 120 the server's SSL version number, cipher settings, randomly generated data, and other information the PDA needs to communicate with the server over SSL. The server 112 may also send its own certificate, such as the certificate 300 shown in FIG. 3, and may optionally request the PDA's certificate, if the client using the PDA 120 is requesting a server resource that requires client authorization. In the alternative the server and PDA may obtain the other's certificate from the certificate repository.

The PDA may then use the server's certificate to authenticate the server 112. To authenticate the server 112, the PDA 120 may first look at the validity range 420 to see if the present date is within the date range of the validity range 420. If the present date is within the validity range, the PDA 120 may then look at the issuer name 416 to see if the CA is a trusted CA. If the PDA determines that the CA is a trusted CA, then the PDA 120 may check to see if the CA's public key is able to validate the digital signature 308. In order to see if the CA's public key is able to validate the digital signature 308, the PDA 120 would use the public key of the CA to decrypt the signature to see if the decrypted signature matches the certificate information 304. If the CA used an RSA algorithm, the PDA 120 may be able to handle such an RSA decryption in a reasonable time, since generally the use of an RSA public key may be more efficient than using an RSA private key. Otherwise the user may need to wait if the PDA 120 needs extra time to perform this operation. If the public key is able to validate the digital signature 308, the PDA may also check that the domain name specified in the subject name 424 matches the domain name of the server 112. If all these conditions are met, the PDA 120 may proceed to the next step in the SSL handshake. If the present date is not within the validity range, the CA is not a trusted CA, or the CA's public key is not able to validate the digital signature 308, then the PDA might not establish a secure connection with the server 112 or the connection may be terminated. To more completely confirm the identity of the server 112, the PDA 120 may encrypt a message using the server's public key listed in the certificate. The server 112 would use the server's private key to decrypt the message and send a reply. The PDA 120 would be able to determine that the reply came from the server 112, if the reply is the proper response to the message.

In some transactions the server 112 must be able ensure the identity of the PDA 120. In such cases, the server 112 may request the certificate of the PDA 120. The PDA 120 may transmit the PDA's certificate 300 and a separate piece of digitally signed data to the server 112. To create the digitally signed data, the PDA 120 may hash data generated during the handshake and then use the PDA's private key to encrypt the hashed information. If the PDA 120 used the first private key, which is an RSA type private key, the PDA 120 may need an undue amount of time to encrypt the message. This is due to RSA type messages generally being more difficult to encrypt than ECC type messages and due to private keys generally taking longer to use than public keys. Since the PDA 120 is able to encrypt the message using an ECC private key, the PDA 120 is able to encrypt the message faster and within a more preferred time span and possibly with less bandwidth. The signature algorithm identifier 412 in the PDA's certificate may indicate the CA's hashing algorithm and key type. The server 112 may then use the information sent by the PDA 120 to authenticate the PDA 120. To authenticate the PDA 120, the server 112 may first look at the validity range 420 to see if the present date is within the date range of the validity range 420. If the present date is within the validity range, the server 112 may then look at the issuer name 416 to see if the CA is a trusted CA. If the server 112 determines that the CA is a trusted CA, then the server 112 may check to see if the CA's public key is able to validate the digital signature 308. In order to see if the CA's public key is able to validate the digital signature 308, the server 112 would use the public key of the CA to decrypt the signature to see if the decrypted signature matches the certificate information 304. If the public key is able to validate the digital signature 308, the server 112 may also check that the domain name specified in the subject name 424 matches the domain name of the server 112. The server 112 may then use the PDA's public key to decrypt the signature and compare it with the data created during the handshake. The server 112 may look at a clear text statement, a header sent with the message, or text in a certificate to determine what algorithm should be used to decrypt the signature with the PDA's public key. The clear text statement, header, or text in the certification may state that the ECC public key in the extension of second public key information field 432 be used for an ECC type decryption. The server 112 would then comply and use the ECC public key in the extension field 432 to decrypt the signature, which is compared with the data created during the handshake. Further discussion of the use of the digital signature is more completely discussed below regarding digitally signed documents. If all these conditions are met, the server 112 may proceed to the next step in the SSL handshake. If the present date is not within the validity range, the CA is not a trusted CA, or the CA's public key is not able to validate the digital signature 308, then the server 112 might not establish a secure connection with the PDA 120 or the connection may be terminated.

To more completely confirm the identity of the PDA 120, the server 112 may encrypt a message using the PDA's public key listed in the certificate. A clear text statement or a header sent with the message or text in the certificate may be used to determine what algorithm should be used to encrypt the message with the PDA's public key. The clear text statement or header may state that the ECC public key in the extension of second public key information field 432 be used for an ECC type encryption. The server 112 would then comply and use the ECC public key in the extension field 432 to encrypt a private message, which is sent to the PDA 120. The PDA would use the PDA's private ECC key to decrypt the message and send a reply. If the PDA 120 needed the RSA private key to decrypt the message the PDA 120 may need an undue amount of time to decrypt the message. This is due to RSA type messages generally being more difficult to decrypt than ECC type messages and due to private keys generally being less efficient than public keys. Since the PDA 120 is able to decrypt the message using an ECC private key, the PDA 120 is able to decrypt the message faster and within a more preferred time span. The PDA 120 then sends a response to the server 112. The server 112 would be able to determine that the reply came from the PDA 120, if the reply is the proper response to the message.

After the identities of the PDA 120 and server 112 have been sufficiently identified a session key, which is a symmetric key to be used by the PDA 120 and server 112 to both encode and decode messages during the session, is generated. Such symmetric keys may provide a faster and more secure encryption.

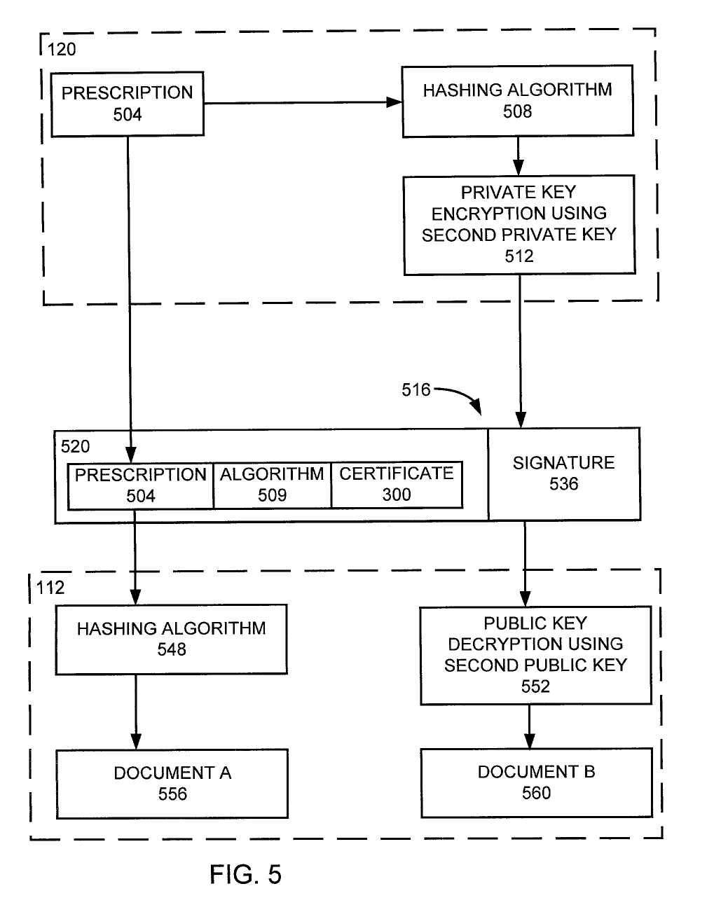

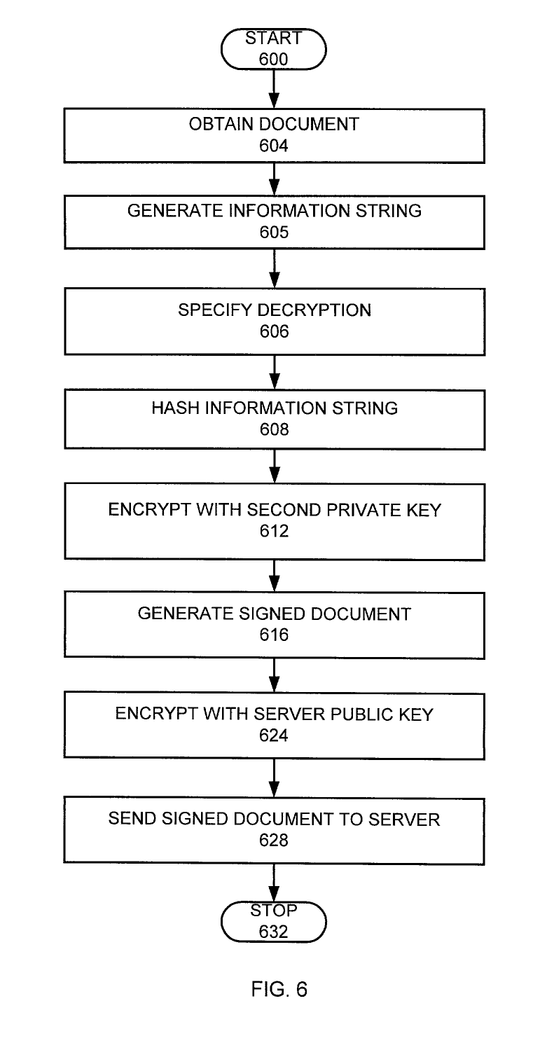

During or at the end of the session it may be desirable to have the PDA 120 provide a digitally signed document, in which it may be verified immediately or later that the document was approved by the user of the PDA 120. To facilitate understanding, FIG. 5 is a schematic illustration of the generation by the PDA 120 of a digitally signed document and the verification of the signed document by the server 112. FIG. 6 is a flow chart of the generation of the digitally signed document. First a document is obtained (step 604). The document may be generated by the PDA 120. It may be downloaded to the PDA 120 as a form with information filled in. The document could be a contract, a financial transaction, an image, or any other such computer file or files. In the example, illustrated in FIG. 5, the document is a prescription 504 generated by a physician, which uses the PDA 120. If the server 112 is connected to a pharmacy that fills the prescription, it would be desirable that the electronic prescription be in a form that allows the server 112 and pharmacy to show that the physician authorized the electronic prescription 504. An information string 520 is generated (step 605), which may contain the prescription 504, a hashing algorithm and encryption algorithm 509, and the PDA's 120 certificate 300. Other embodiments may not place the certificate within the information string, such as when the server may be able to obtain the certificate from a certificate repository. Within the algorithm 509 in the information string 520 may be an algorithm that specifies that the public key in the extension of the certificate should be used to decrypt the signature using an ECC type of decryption (step 606) and may also include the hashing algorithm 508. The information string 520 is subjected to a one way hashing algorithm 508 (step 608) creating a hash of the information string. The hash is then encrypted using the second private key 512 (step 612), which is the ECC key. The use of the ECC private key allows the PDA 120 to provide encryption within a reasonable time frame, since the use of an ECC key is generally faster than the use of an RSA key. The first and second private keys may be password protected so that if another person obtains access to the PDA 120 they will not able to encrypt or decrypt with the physician's private key. The PDA then generates a signed document 516 (step 616). The signed document 516 may comprise the information string 520 and a signature 536. The signature 536 comprises the encrypted hash of the information string 520. The information string 520 and possibly even the signature 536 may be further encrypted with the public key of the server 112 to prevent others from knowing the content of the prescription (step 624). This step may be possible to accomplish on the PDA 120 within a reasonable time because the use of a public key may be generally faster than the use of a private key. The signed document 516 may then be sent to the server 112 through the network 102 (step 628).

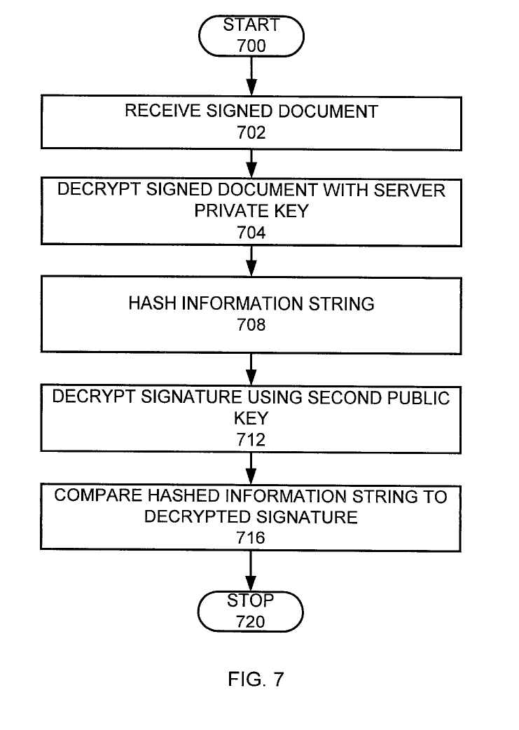

FIG. 7 is a flow chart of the authentication of the signed document by the server 112. The server 112 receives the signed document through the network 102 (step 702). If part of the signed document has been encrypted with the server's public key, that part is decrypted using the server's private key (step 704). The information string 520 is hashed according to the hashing algorithm, which is taken from the algorithm 509 described in the information string 520 to generate document A 556 (step 708). The signature 536 is decrypted using the second public key 536 as specified in the certificate 300 or in another place in the information string 520 to generate document B 560 (step 712). Document A is then compared to document B (step 716). If document A 556 is identical to document B 560, the server 112 has authenticated that the signed document 516 was approved by the PDA 120, where the hashing proves that no third party, including the server 112 has changed the contents of the prescription. In another embodiment, less information such as only the prescription may be hashed and placed into the digital signature.

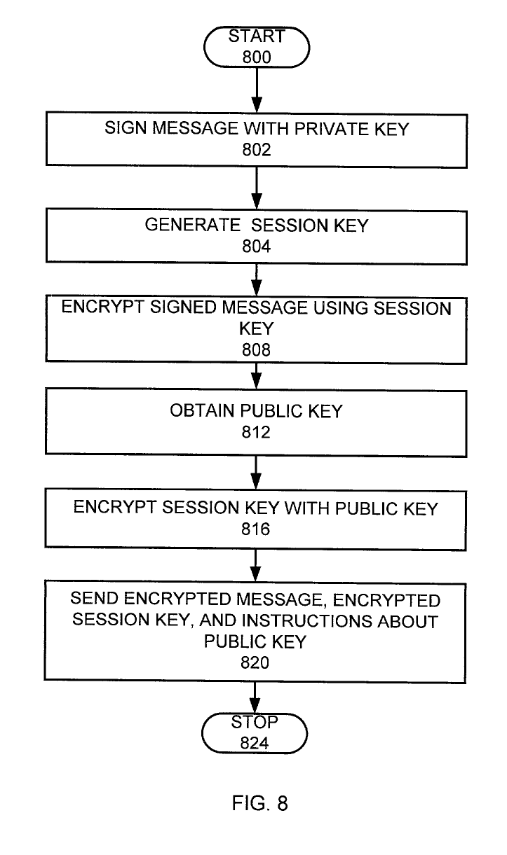

FIG. 8 is a flow chart for initiating a secure session, initiated by a PDA, used in another embodiment of the invention. In an alternative to the SSL process described in the previous embodiment, this embodiment may be used when the PDA has obtained a server's certificate from a trusted repository and the server obtains the PDA's certificate from a trusted repository. The PDA obtains a message and signs the message with the PDA's private key (step 802). The private key used for the signing is a private key in the extension of the RSA certificate. Such a key is easier for the PDA to use than and is at least as secure as the standard RSA key in the standard key location of the certificate. Such private keys may be ECC keys or NTRU keys or other keys that are more secure and easier to use than RSA keys.

A session key is generated (step 804). The session key is a symmetrical key that will be used by the PDA and server. The signed message is encrypted by the PDA using the session key (step 808). The PDA obtains the public key of the server (step 812). One way of obtaining the public key is by obtaining the certificate of the server from a trusted repository. As discussed above, the PDA may authenticate the certificate. When the PDA determines that the certificate is reliable, the PDA obtains the public key of the server from the certificate. The PDA encrypts the session key using the server's public key (step 816). The encrypted message, the encrypted session key, and instructions about the public key are sent from the PDA to the server (step 820). Instructions about the public key may be encrypted or may be clear text or in the form of a header.

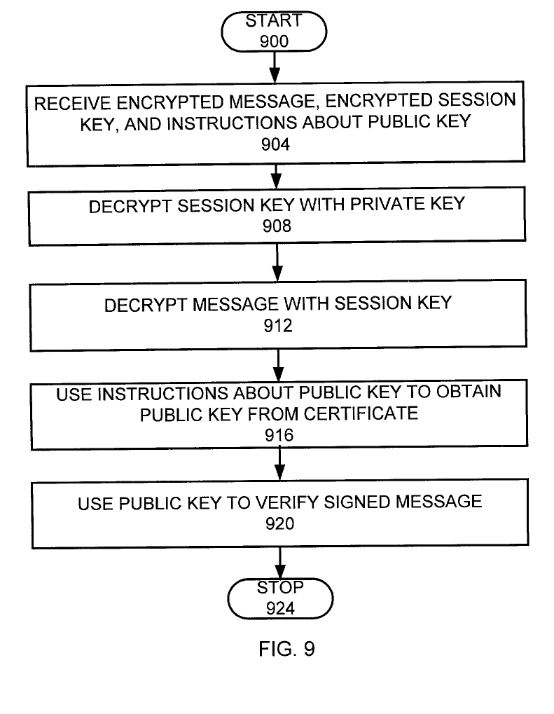

FIG. 9 is a flow chart for the completion of initiating a secure session. The server receives the encrypted message, the encrypted session key, and instructions about the public key from the PDA (step 904). The server decrypts the session key using the server's private key (step 908). The server decrypts the message using the session key (step 912). The server then uses the instructions about the public key to obtain the public key from the certificate (step 916). These instructions would specify that the public key is in the extension of the certificate and may specify the type of encryption used. For example, the instructions may state that the public key to be used to verify the signature is in a first extension of the certificate and that an ECC type of encryption was used. In another example, the instructions may state that the public key to be used to verify the signature is in the third extension of the certificate and a NTRU type of encryption was used. In another example, the instructions may only state that the public key is in the first extension. The type of encryption and value are placed in the first extension. The public key obtained from the PDA's certificate is then used to verify the signed message (step 920).

In other embodiments, other public keys may be placed in other extensions of a certificate, so that a certificate may have more than two public keys of different public key types. A key may be placed in more than one extension, such as placing the key type in one extension and the key value in another extension. Such public keys may allow a reduction in bandwidth to allow real time security during wireless or other transactions with lower bandwidth. The invention allows the use of the most widely used encryption algorithm, which is presently RSA, to obtain a widely recognizable certification while allowing an encryption using a method that may be better for one or more reasons than the most widely used certification algorithm. The invention also provides a certification that may be used on both a desktop computer and compact devices, such as PDA's, wireless devices, smart cards, and tokens. Other benefits of having different types of public keys in a certificate may also become obvious.

While this invention has been described in terms of several preferred embodiments, there are alterations, permutations, and substitute equivalents, which fall within the scope of this invention. It should also be noted that there are many alternative ways of implementing the methods and apparatuses of the present invention. It is therefore intended that the following appended claims be interpreted as including all such alterations, permutations, and substitute equivalents as fall within the true spirit and scope of the present invention.

What is claimed is:

1. A method of forming a certificate, comprising:
placing a first public key of a first encryption type in the certificate; and
placing a second public key of a second encryption type in the certificate.

2. The method, as recited in claim 1, wherein the second public key is placed as at least one extension of the certificate.

3. The method, as recited in claim 2, wherein the second encryption type is faster than the first encryption type.

4 The method, as recited in claim 3, wherein the extension where the second public key is placed specifies a key type, a key length, and a key value.

5. The method, as recited in claim 4, wherein the placing of the first public key and the placing of the second public key places the first and second public keys in a certificate information string, where the extension is part of the certificate information string and further comprising:
creating a signature from the certificate information string; and
adding the signature to the certificate information string to form the certificate.

6. The method, as recited in claim 5, further comprising:
placing a hashing algorithm in the certificate information string, wherein the hashing algorithm is used to create the signature; and
placing a certificate authority identifier, which identifies a certificate authority, in the certificate information string.

7. The method, as recited in claim 6, wherein a private key of the certificate authority is used to generate the signature.

8. The method, as recited in claim 1, wherein the placing of the first public key and the placing of the second public key places the first and second public keys in a certificate information string and further comprising:
creating a signature from the certificate information string; and
adding the signature to the certificate information string to form the certificate.

9. The method, as recited in claim 8, further comprising:
placing a hashing algorithm in the certificate information string, wherein the hashing algorithm is used to create the signature; and
placing a certificate authority identifier, which identifies a certificate authority, in the certificate information string, wherein a private key of the certificate authority is used to generate the signature.

10. A method for transmitting a document comprising digitally signing the document, comprising:
encrypting an information string with a private key to create a signature, wherein the private key is related to a public key in a certificate, wherein the certificate comprises a first public key and a second public key, wherein the public key related to the private key is the second public key and wherein the information string contains the document; and
attaching the signature to the information string to create a digitally signed document.

11. The method, as recited in claim 10, wherein the first public key is a first encryption type and the second public key is a second encryption type, which is different from the first encryption type.

12. The method, as recited in claim 11, wherein the second encryption type is faster than the first encryption type.

13. The method, as recited in claim 12, wherein the second public key is placed in an extension of the certificate.

14. The method, as recited in claim 13, further comprising adding text to digitally signed document to specify the location of the second public key in the certificate.

15. The method, as recited in claim 14, further comprising hashing the information string, so that the encrypting of the information string encrypts the hashed information string.

16. The method, as recited in claim 15, wherein the extension where the second public key is placed specifies a key type, a key length, and a key value.

17. The method, as recited in claim 16, wherein the certificate further comprises an issuer name, a validity range, and a subject name.

18. The method, as recited in claim 11, further comprising:
transmitting the digitally signed document from a first device; and
receiving the digitally signed document at a second device.

19. The method, as recited in claim 18, wherein the certificate is the certificate for the first device, further comprising:
obtaining the second public key from an extension of the certificate for the first device; and
using the second public key to verify the digitally signed document.

20. The method, as recited in claim 19, further comprising receiving at the second device instructions designating the location of the second public key an the extension of the certificate.
